(19) United States
(12) Patent Application Publication
(10) Pub. No.: US 2010/0278464 A1
(43) Pub. Date: Nov. 4, 2010

(54) Blade Gasodynamic Bearing

(76) Inventor: Yury Ivanovich Ermilov, Moscow (RU)

Correspondence Address: Ermilov Yury Ivanovich, 119361 Flat 103 Ozernaya St 23/2, Moscow, RU

(21) Appl. No.: 12/673,162

(22) PCT Filed: Jul. 9, 2008
(86) PCT No.: PCT/RU2008/000448

§ 371 Date: May 3, 2010

(30) Foreign Application Priority Data
Aug. 13, 2007 (RU) 2007130761

(51) Int. Cl. F16C 32/06

(52) U.S. Cl. 384/103

(57) ABSTRACT

The invention is related to mechanical engineering in particular to compliant foil hydrodynamic bearings which is used in small-size high speed machines such as turbocompressors, cooling turbines etc. The inventive foil hydrodynamic bearing comprises a bearing case (7), a journal (1), a compliant smooth top foil (15) and elastically damping sections, each of which consists of a spring element (25) (for example, a corrugated foil) and compliant smooth inner foils (27, 30, 33), which are fixed by one end thereof to the bearing case on both sides of the spring element. The increased frictional damping of the bearing at small rotating frequencies is obtained by that, when the journal 1 is shifted, a sliding motion with friction takes place between the contacting surfaces of the inner foils of the elastically damping sections.

### TECHNICAL FIELD

The invention is related to mechanical engineering in particular to compliant foil hydrodynamic bearings which is used in small-size high speed machines such as turbocompressors, cooling turbines etc.

### BACKGROUND ART

The known foil hydrodynamic bearing (U.S. Pat. No. 4,415,280) comprises the bearing case, the journal, disposed inside the bearing case, a compliant smooth top foil, disposed inside the space between the bearing case inner cylindrical surface and the journal, said foil fixed in axial direction to the bearing case by one end thereof and extending around the journal. The spring element in form of corrugated foil is disposed between the bearing case inner surface and the top foil. The compliant smooth inner foil is disposed between the top foil outer surface and the spring element inner surface. The inner foil is fixed in the direction of bearing axis by one end thereof to the bearing case so that the inner foil and the top foil are extending from their fixed ends to the fixed ends around the journal in the opposite directions by the angle a bit less than 360 Grad.

At radial oscillations of the rotor in the foil hydrodynamic radial bearing there arise frictional damping of the oscillations because of sliding bearing elements relatively each other: foils, the corrugated foil and the bearing case.

Frictional damping arises in the contacts between the corrugated foil and the bearing case, between the inner foil and the corrugated foil, and also between the top and inner foils. Frictional forces generating frictional damping between the top and inner foils give extension to foils that is passed to fixing ends thereof.

At small rotation speed there is small pressure in the lubricating layer between the top foil and the journal in the zones near of fixing foils parts. It takes place because of enough a big thickness of lubricating layer. Under this reason, under small journal displacement in the direction from the place of fixing foils does not arise relative sliding of foils and damping because parts of foils is in the zones, where there are big thickness of lubricating layer, firstly begin moving to the shaft. Only when the top foil above completely presses to the shaft, further journal displacement in the same direction generate sliding of foils and damping.

Reduced damping capacity of said foil hydrodynamic radial bearing at small journal rotation speed is a disadvantage because resonant rotor oscillations arise in bearings at start/stop. Low damping causes an increase in magnitude of resonant rotor oscillations and leads to necessity to increase radial gaps between stationary parts and compressor wheel or turbine wheel that decreases high speed machines efficiency.

### SUMMARY OF THE INVENTION

The object of the presented invention is to increase damping capacity of foil hydrodynamic radial bearing at small rotor revolution speed.

The appointed object is achieved by the following way. The foil hydrodynamic radial bearing comprises the bearing case with journal, compliant smooth top foil.

The top foil is disposed in the annular space between the bearing case inner surface and the journal and extends around the journal. The top foil adjoin by their inner surface to the journal. One end of the top foil is fixed in the direction of bearing axis to the bearing case. Between top foil outer surface and the bearing case inner surface there are disposed in the circumferential direction two or more elastically damping sections. Each of said sections comprises the spring element (for example, a corrugated foil) disposed between the bearing case inner surface and the top foil outer surface and two or more compliant smooth inner foils disposed between the spring element inner surface and the top foil outer surface. One end of inner foil is fixed in direction of the bearing axis to the bearing case. At least in one of elastically damping sections two inner foils, that adjoining each other by outer and inner surfaces, are fixed to the bearing case near opposite ends of the spring element.

### DESCRIPTION OF THE EMBODIMENT

Embodiment of the present invention is explained below by reference to the attached drawing.

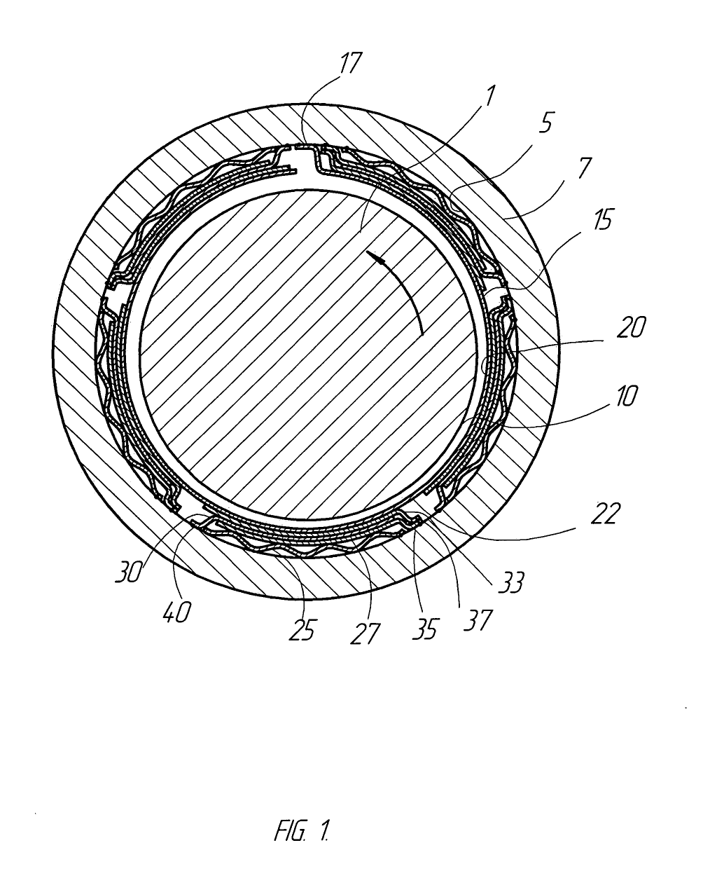

FIG.1 illustrates the cross sectional view of the radial foil hydrodynamic bearing.

The foil hydrodynamic radial bearing comprises the rotor journal 1 disposed inside the hole of the bearing case 7. Compliant smooth top foil 15 adjoined by inner surface 20 to the rotor journal 1 is disposed in annular space between the inner surface 5 of the bearing case 7 and the surface 10 of the journal 1 The end 17 of top foil is fixed in the direction of bearing axis to the bearing case, for example by welding. The top foil extends in the circumferential direction around the journal by the angle a bit less than 360 Grad

The unfixed end of the top foil forms a small gap with the fixed part of top foil.

Several (at least two) elastically damping sections are disposed in the circumferential direction between the outer surface 22 of top foil and the bearing case inner surface. The bearing shown in FIG. 1 has five such sections. Each elastically damping section comprises the spring element (for example, a elastic corrugated foil) 25 and compliant smooth inner foils 27, 30, 33. The inner foil 27 contacts by its outer surface with the spring element inner surface. The inner foil 30 contacts by its outer surface with the inner surface of inner foil 27. The inner foil 33 contacts by its outer surface with the inner surface of inner foil 30. The number of inner foils in the elastically damping section may be equal to two or more. The inner foils 27, 30 and 33 are fixed near spring element 25 to the bearing case along one end in the direction of bearing axis. One of the manners to fix inner foils is welding. The inner foils 27 and 30 are directly fixed by parts 35 and 40 to the bearing case. If number of inner foils in the section more than two, part of inner foils may be fixed to the bearing case by fixing parts of underlying inner foils. For example, overlying inner foil 33 is fixed by its part 37 to the bearing case thorough fixing part 35 of the underlying inner foil 27. FIG. 1 shows one of possible variants to dispose inner foils fixing parts in the section wherein each pair of contacting inner foils (pair of foils 27 [symbol] 30, pair of foils 30 [symbol] 33) is fixed to the bearing case near opposite ends of the spring element.

In the operation of the foil hydrodynamic bearing-according to the embodiment of the present invention, rotating journal surface 10 entrains in the circumferential direction the air in lubricating layer between top foil inner surface 20 and the journal surface 10, that is from inlet to outlet disposed at free end and fixed end 17 of the top foil. Air pressure in lubricating layer increases with decrease in layer thickness by reason of air viscosity. At some rotation speed the value of pressure becomes sufficient to prevent contact between the journal 1 and the top foils inner surfaces 20.

FIG. 1 shows the variant of disposing bearing where bearing load under rotor weight passes to the low part of bearing case in the zone of small thickness in lubricating layer. At small rotation speed, big lubricating layer overpressure is only in said zone and main part of bearing load is passed to the bearing case through the top foil and the low elastically damping section: inner foils 33, 30, 27 and the spring element 25.

Arising oscillations of the rotating shaft in the foil hydrodynamic radial bearing are accompanied with frictional damping because of sliding bearing elements relatively each other: top and inner foils, spring elements and the bearing case.

At vertical oscillations of the shaft and small rotation speed the main part of frictional damping is generated at the bearing low part where contact pressure between bearing elements is maximal.

The reason, why frictional damping diminishes in zones of contact between the top foil and foils of sidelong elastically damping sections from the side of the top foil fixed end, is following. When the journal moves down, the top foil low part also moves down under pressure of lubricating layer, and frictional force between the top foil 15 and foil 33 in the bearing low part causes tension of the top foil approximately in the zone extending from its fixing part 17 till the contacting zone of low section with the foil 33. Under this tension, the top foil displaces from said sidelong elastically damping sections and moves to the journal, because there is small over pressure in this zone of lubricating layer. At such movement, frictional damping does not arise. When the journal moves up, the top foil comes back to said sidelong elastically damping sections, that does not cause frictional damping either.

When the journal moves down, the top foil and elastically damping section inner foils displace down under lubricating layer pressure, inner and outer surfaces of the inner foil 30 displace relatively the bearing case in a clockwise direction to fixing part of inner foil 30. Surfaces of inner foils 33 and 27 displace in a counterclockwise direction. Said displacement of contacting inner foils in different directions generates friction forces between inner foils 33 and 30 and between inner foils 30 and 27. Angle length of elastically damping sections is so that practically all low part of said section is disposed in high pressure zone and small thickness of lubricating layer. That is why under friction forces the inner foils in said section cannot approach to the journal and straighten, so they have to slide relatively each other generating frictional damping. When the journal moves up, that is in backward direction, inner foils of said section return to the initial place and also slide relatively each other generating frictional damping.

When the shaft oscillates in another direction or in case of shaft circular precession, by the same way, as a result of journal movement, there arises friction damping in other deforming elastically damping sections.

Friction damping between inner foils of elastically damping section increases at increase in number of inner foils contacting couples. If the elastically damping section has only two inner foils, there is one inner foil contacting couple. If the elastically damping section has three inner foils, as it is shown in FIG. 1, there are two inner foils contacting couples and in this case the friction damping will be more than at two inner foils in the section.

1. A foil hydrodynamic bearing, comprising:
a journal disposed inside the hole of the bearing case;
the compliant top foil disposed in the annular space between the bearing case inner surface and the journal, said foil extending around the journal and adjoining by its inner surface to the journal, and fixed in the direction of bearing axis by one end thereof to the bearing case;
at least two elastically damping sections, disposed in the circumferential direction between the top foil outer surface and the bearing case inner surface,
wherein
each elastically damping section comprises:
the spring element disposed between the top foil outer surface and the bearing case inner surface and
at least two compliant inner foils disposed between the spring element inner surface and the top foil outer surface, and fixed in the direction of bearing axis by one end thereof to the bearing case;
wherein
at least in one of elastically damping section two inner foils contacting by their outer and inner surfaces, are fixed to the bearing case near opposite ends of the spring element.

2. The bearing according to claim 1 wherein the top foil and inner foil are smooth.

3. The bearing according to claim 1 wherein the spring element is made of corrugated foil.

4. The bearing according to claim 1 top foil extended from its unfixed end to the fixed end in the direction of rotor rotating.

5. The bearing according to claim 1 wherein each elastically damping section comprises contacting inner foils fixed to the bearing case near opposite ends of the spring element.

6. The bearing according to claim 1 wherein top foil and inner foils are fixed to the bearing case by welding.
